(19) United States
(12) Patent Application Publication
(10) Pub. No.: US 2018/0063179 A1
(43) Pub. Date: Mar. 1, 2018

(54) System and Method Of Performing Online Memory Data Collection For Memory Forensics In A Computing Device

(71) Applicant: QUALCOMM Incorporated, San Diego, CA (US)

(72) Inventors: Mastooreh Salajegheh, Santa Clara, CA (US); Sudha Anil Kumar Gathala, Tracy, CA (US); Saumitra Mohan Das, San Jose, CA (US); Nayeem Islam, Palo Alto, CA (US)

(21) Appl. No.: 15/248,178

(22) Filed: Aug. 26, 2016

(51) Int. Cl. H04L 29/06; G06F 1/28

(52) U.S. Cl. CPC H04L 63/1433; G06F 1/28; H04L 63/1408

(57) ABSTRACT

Various embodiments include methods and a memory data collection processor for performing online memory data collection for memory forensics. Various embodiments may include determining whether an operating system executing in a computing device is trustworthy. In response to determining that the operating system is not trustworthy, the memory data collection processor may collect memory data directly from volatile memory. Otherwise, the operating system to collect memory data from volatile memory. Memory data may be collected at a variable memory data collection rate determined by the memory data collection processor. The memory data collection rate may depend upon whether an available power level of the computing device exceeds a threshold power level, whether an activity state of the processor of the computing device equals a sleep state whether a security risk exists on the computing device, and whether a volume of memory traffic in the volatile memory exceeds a threshold volume.

### BACKGROUND

Memory forensics is an analysis of a computer's volatile memory to determine information about executing programs, the operating system, and/or the overall state of the computer. Memory forensics may be useful for detecting malicious software (i.e., malware) executing in the computer's memory. Malware may include any software that is used to disrupt computer operations, gather sensitive information, gain access to private computer systems, or display unwanted advertising. Malware may include, but is not limited to, computer viruses, worms, rootkits, Trojan horses, ransomware, spyware, adware, scareware, and other malicious software.

Memory forensics typically involves collecting memory data that represents the state of the computer's volatile memory at a specific time and is sometimes referred to as creating a “memory snapshot” or “memory dump.” Types of memory data collected for memory forensics may include information on memory usage, such as map files, mem files, proc files, and other data about processes and other system information, for example.

Memory data collection may be performed offline or online. Offline memory data collection occurs when a computer is no longer operating, such as after a program crash due to a computer attack. With offline memory data collection, there is a risk of losing memory content before it is collected, particularly if power is lost. Online memory data collection occurs while the computer in operation. With online memory data collection, there is less risk of memory content loss and thus is more reliable.

### SUMMARY

Various embodiments include methods and a memory data collection processor for performing online memory data collection for memory forensics in a computing device. Various embodiments may include a memory data collection processor determining whether an operating system executing in a computing device is trustworthy. In response to determining that the operating system is not trustworthy, the memory data collection processor may collect memory data directly from volatile memory. In response to determining that the operating system is trustworthy, the memory data collection processor may call the operating system to collect memory data from volatile memory.

In some embodiments, collecting memory data from the volatile memory may include collecting the memory data from the volatile memory at a variable memory data collection rate determined by the memory data collection processor. Some embodiments may further include the memory data collection processor determining whether an available power level of the computing device exceeds a threshold power level, and setting the variable memory data collection rate at or near a maximum rate in response to determining that the available power level of the computing device exceeds the threshold power level. Some embodiments may further include the memory data collection processor determining whether an activity state of the processor of the computing device equals a sleep state, and setting the variable memory data collection rate towards a minimum rate in response to determining that the activity state of the processor is equal to the sleep state. Some embodiments may further include the memory data collection processor obtaining information indicating whether a security risk exists on the computing device, and setting the variable memory data collection rate at or near a maximum rate in response to determining that the information indicates that a security risk exists on the computing device. Some embodiments may further include the memory data collection processor determining whether a volume of memory traffic in the volatile memory exceeds a threshold volume, setting the variable memory data collection rate at or near a maximum rate in response to determining that the volume of memory traffic in the volatile memory exceeds the threshold volume, and setting the variable memory data collection rate at or near a minimum rate in response to determining that the volume of memory traffic in the volatile memory does not exceed the threshold volume.

In some embodiments, collecting memory data from the volatile memory may include the memory data collection processor collecting a partial data set from the volatile memory, in which the partial data set includes data associated with one or more suspicious processes executing in the volatile memory. In some embodiments, collecting memory data from the volatile memory may include collecting a partial data set from the volatile memory, wherein the partial data set includes less than all data associated with each process executing in the volatile memory. In some embodiments, determining whether the operating system executing in the volatile memory is trustworthy may include the memory data collection processor determining whether the operating system satisfies a real time integrity check.

Further embodiments may include a computing device having a volatile memory, a processor coupled to the memory, and a memory data collection processor coupled to the memory and the processor and configured to perform operations of the methods summarized above. Further embodiments may include a computing device having means for performing functions of the methods summarized above. Further embodiments may include a non-transitory medium on which is stored processor-executable instructions configured to cause a memory data collection processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram illustrating components of a computing device that may be configured to perform online memory data collection according to some embodiments.

FIG. 2 is a process flow diagram illustrating a method of performing online memory data collection suitable for use with various embodiments.

FIG. 3 is a process flow diagram illustrating a method of controlling a rate of performing the method of online memory data collection according to some embodiments.

FIG. 4 is a schematic diagram illustrating components of a smartphone type mobile communication device suitable for use with various embodiments.

FIG. 5 is a schematic diagram illustrating components of a laptop computing device suitable for use with various embodiments.

FIG. 6 is a schematic diagram illustrating components of a server suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and hardware implementing such methods for efficiently performing memory collections (i.e., “snapshots”) on computing devices.

The term “computing device” is used herein to refer to an electronic device equipped with at least a processor. Examples of computing devices may include, but not limited to, mobile communication devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

Operating systems typically provide application program interfaces (“APIs”) and/or file systems that may be used for online collection of memory data associated with one or more processes, e.g., for memory forensics. For example, in Unix-like operating systems (OS), a proc filesystem (“procfs”) may be used to access information about processes and other system information maintained in the OS in a hierarchical file-like structure. However, an OS cannot necessarily be trusted, particularly when the computer is suspected of executing malware or under attack by a malicious computer hacker. For example, a malicious computer attack may compromise the integrity of an OS, configuring the OS to provide the inaccurate information regarding the memory content for a specific process, thus defeating memory forensic techniques.

Various embodiments are disclosed for performing online memory data collection using a memory data collection processor to ensure accurate data collections are reliably performed in the event the OS is compromised. Various embodiments may include determining whether the operating system (“OS”) executing in the volatile memory of a computing device is trustworthy. In response to determining that the OS is trustworthy, the memory data collection processor may call the OS to collect the memory data. In response to determining that the OS may not be trustworthy, the memory data collection processor may read the memory data direct from the volatile memory. In some embodiments, the memory data collection processor may determine whether the OS is trustworthy by determining whether the OS satisfies a real-time integrity check (RTIC). In some embodiments, the memory data collection processor may be an electronic component external to a processor that executes the OS in the volatile memory.

In some embodiments, the memory data collection processor may be configured to perform online memory data collection at a variable memory data collection rate that depends on certain factors or triggers. Such factors or triggers may include, but are not limited to, an available power level of the computing device (e.g., battery life), the activity state of the processor, whether a security risk exists on the computing device, the volume of memory traffic (i.e., reads/write accesses), and any combination thereof. Various embodiments may be particularly useful for memory forensics.

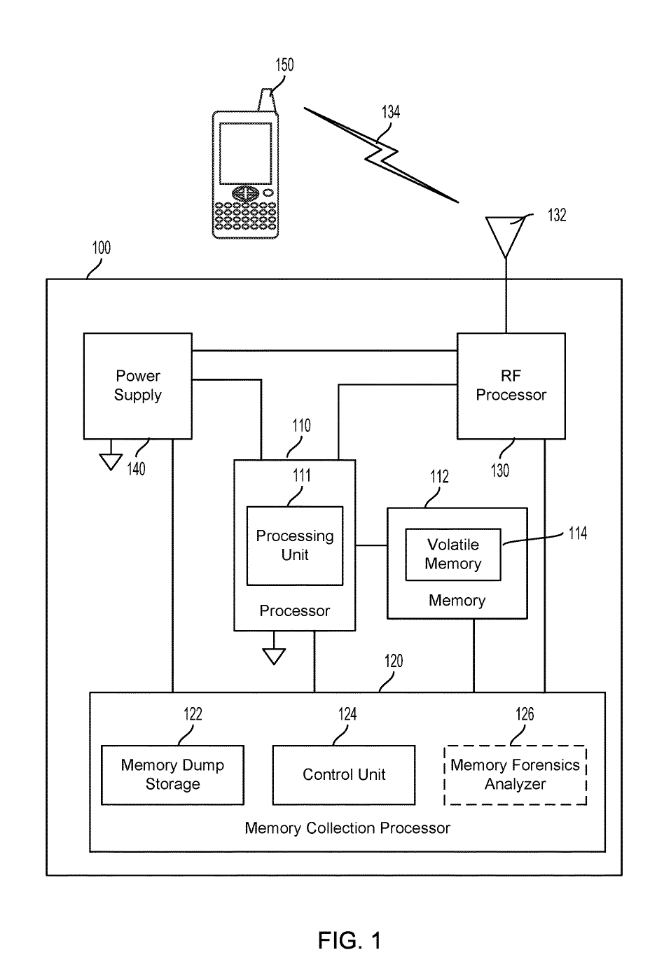

FIG. 1 is a schematic diagram illustrating components of a computing device 100 that may be configured to perform online memory data collection according to some embodiments. The computing device 100 may include various circuits and other electronic components used to power and control the operation of the computing device 100. The computing device 100 may include a processor 110, memory 112, a memory data collection processor 120, a radio frequency (RF) processor 130 coupled to an antenna 132, and a power supply 140.

In some embodiments, the processor 110 may be dedicated hardware specifically adapted to perform various operations of the computing device 100, including, but not limited to, executing an operating system and/or various instances of one or more programs (i.e., processes). In some embodiments, the processor 110 may be or include a programmable processing unit 111 that may be programmed with processor-executable instructions to perform the various operations of the computing device 100. In some embodiments, the processor 110 may be a programmable microprocessor, microcomputer or multiple processor chip or chips that can be configured by software instructions to perform the various operations of the computing device 100. In some embodiments, the processor 110 may be a combination of dedicated hardware and a programmable processing unit 111.

In some embodiments, the memory 112 may store processor-executable instructions. In some embodiments, the memory 112 may be volatile memory, nonvolatile memory (e.g., flash memory), or a combination thereof. In some embodiments, the memory 112 may include internal memory included in the processor 110, memory external to the processor 110, or a combination thereof. In some embodiments, the memory 112 may include volatile memory 114, such as random access memory (RAM), in which an operating system and various instances of one or more programs (i.e., processes) may be executed by the processor 110.

In some embodiments, the memory collection processor 120 may be dedicated hardware specifically adapted to perform online memory data collection for memory forensics in the computing device 100. In some embodiments, the memory data collection processor 120 may include a memory dump storage 122 and a programmable control unit 124 that may be programmed with processor-executable instructions to control performance of the online memory data collection from the volatile memory 114 using the memory dump storage 122. In some embodiments, the memory data collection processor 110 may be a combination of dedicated hardware, the memory dump storage 122, and the programmable control unit 124. In some embodiments, the memory data collection processor 120 may be a programmable microprocessor, microcomputer or multiple processor chip or chips that can be configured by software instructions to perform online memory data collection from the volatile memory 114 using the memory dump storage 122.

In some embodiments, the memory data collection processor 120 may optionally include a memory forensics analyzer 126 that performs a memory forensics analysis on the memory data collected in the memory dump storage 122. In some embodiments, the memory forensics analysis may be performed by a remote computing device (e.g., 150).

In some embodiments, the processor 110 and the memory data collection processor 120 may be coupled to the RF processor 130 in order to communicate with a remote computing device 150. For example, in some embodiments, the RF processor 130 may be configured to receive and transmit signals 134 via the antenna 132, such as signals from/to a remote computing device 150. Such a remote computing device 150 may perform a memory forensics analysis on data collected by the memory data collection processor 120 and transmitted via the RF processor 130. The RF processor 130 may provide information received from a remote computing device 150 to the processor 110 and/or the memory data collection processor 120. The RF processor 130 may be a transmit-only or a two-way transceiver processor. For example, the RF processor 130 may include a single transceiver chip or a combination of multiple transceiver chips for transmitting and/or receiving signals. The RF processor 130 may operate in one or more of a number of radio frequency bands depending on the supported type of communications.

The remote computing device 150 may be any of a variety of computing devices, including but not limited to a processor in cellular telephones, smart-phones, web-pads, tablet computers, Internet enabled cellular telephones, wireless local area network (WLAN) enabled electronic devices, laptop computers, personal computers, server and similar electronic devices equipped with at least a processor and a communication resource to communicate with the RF processor 130. Information may be transmitted from one or more components of the computing device 100 (e.g., the processor 110 or the memory data collection processor 120) to the remote computing device 150 over a wireless link 134 using Bluetooth®, Wi-Fi® or other wireless communication protocol.

The processor 110, the memory 112, the memory data collection processor 120, the RF processor 130, and any other electronic components of the control device 100 may be powered by the power supply 140. In some embodiments, the power supply 140 may be a battery, a solar cell, or other type of energy harvesting power supply.

While the various components of the computing device 100 are illustrated in FIG. 1 as separate components, some or all of the components may be integrated together in a single device or module, such as a system-on-chip module.

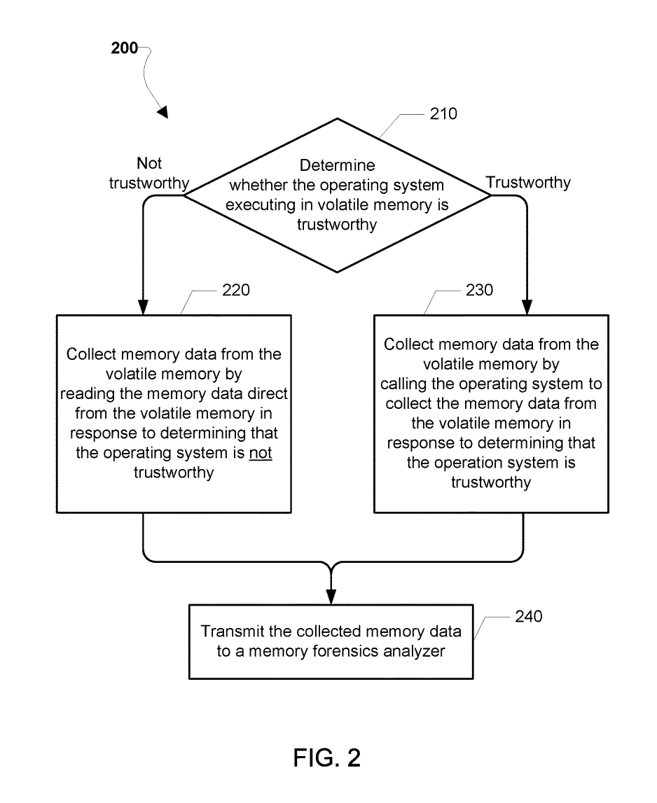

FIG. 2 illustrates a method 200 of performing online memory data collection according to some embodiments. With reference to FIGS. 1-2, operations of the method 200 may be performed by a memory data collection processor of the computing device (e.g., 120 of FIG. 1).

In determination block 210, the memory data collection processor (e.g., 120) may determine whether the operating system executing in volatile memory (e.g. the volatile memory 114 of FIG. 1) is trustworthy. In some embodiments, the memory data collection processor may determine whether an operating system is trustworthy or not based on unexpected changes to one or more OS files or attributes thereof, such as credentials, privileges and security settings, content, core attributes and size, hash values and configuration values. Such changes may increase the risk of a security breach and/or may indicate a security breach in progress.

In some embodiments, the memory data collection processor (e.g., 120) may determine whether the operating system is trustworthy by determining whether the operating system executing in the volatile memory (e.g., 114) satisfies a real time integrity check. A real time integrity check may validate the integrity of one or more OS files or attributes thereof by comparing the current state of such files or file attributes against previously known baselines. For example, in some embodiments, the real time integrity check may include calculating checksums of one or more OS files or file attributes and comparing the calculated checksum against known checksums of such OS files or file attributes.

In some embodiments, the memory data collection processor (e.g., 120) may execute a real time integrity check. In some embodiments, the memory data collection processor (e.g., 120) may obtain the result of a real time integrity check performed by another electronic component of the computing device (e.g., 100). In some embodiments, the real time integrity check may be performed randomly, periodically, quasi-periodically, or each time a memory data collection is to be performed.

In some embodiments, other methods for determining whether the operating system is trustworthy may be employed in block 210, such as malware detection software, such as a security monitoring application or service.

In response to determining that the operating system is not trustworthy (i.e., determination block 210=“Not trustworthy”), the memory data collection processor (e.g., 120) may collect memory data from the volatile memory (e.g., 114) by reading the memory data directly from the volatile memory in block 220. For example, in some embodiments, the memory data collection processor (e.g., 120) may command, request, or otherwise enable the memory dump storage (e.g., 122 of FIG. 1) to read memory data direct from the volatile memory (e.g., 114). In some embodiments, the memory dump storage (e.g., 122) may be configured to read the memory data direct from the volatile memory (e.g., 114) using direct memory access (DMA) or peer-to-peer transfers over a bus architecture. In some embodiments, all write access to the volatile memory (e.g., 114) may be disabled while the memory data is collected. Disabling write access while memory data is collect ensures that a complete image of the memory is obtained.

In response to determining that the operating system is trustworthy (i.e., determination block 210=“Trustworthy”), the memory data collection processor (e.g., 120) may collect memory data from the volatile memory (e.g., 114) by calling the operating system to collect the memory data from the volatile memory in block 230. For example, in some embodiments, the memory data collection processor (e.g., 120) may send signals (e.g., messages) to a processor executing the operating system (e.g., 110) in order to execute one or more OS function calls defined by one or more application program interfaces (“APIs”) or file systems that may be used to collect memory data.

In some embodiments, the memory data collected in blocks 220 or 230 may include all of the memory data stored in the volatile memory (e.g., 114). In some embodiments, the collected memory data may include a partial data set of all the memory data contained in the volatile memory, thereby reducing the power consumption, processing costs and other overhead associated with each memory data collection.

For example, in some embodiments, the partial data set collected in block 220 may include only data associated with one or more suspicious processes executing in the volatile memory. The process identifiers (PIDs) of one or more instances of programs executing in the volatile memory may be identified or marked as suspicious by a security monitoring application or service. In some embodiments, the processor (e.g., 110) or other electronic component of the computing device (e.g., 100) may execute the security monitoring application or service. By collecting memory data associated with only suspicious processes, memory forensics analysis may focus on processes that are security risks while reducing potential performance impacts on the computing device (e.g., 100).

In some embodiments, the partial data set may include a subset of data (i.e., less than all data) for all processes executing in the volatile memory (e.g., 114). For example, in some embodiments, the partial data set for every process may include a set of specific facts (e.g., the memory assigned to each process, the number of forks executed, etc.). By collecting a subset of data associated with each process, memory forensics analysis may focus on analyzing data that is more likely to indicate security risks or security breaches that are in progress while reducing potential performance impacts on the computing device (e.g., 100).

In block 240, the memory data collection processor (e.g., 120) may transmit the collected memory data to a memory forensics analyzer. For example, in some embodiments, the memory data collection processor (e.g., 120) may transmit the collected memory data from the memory dump storage (e.g., 122 of FIG. 1) to a remote computing device (e.g., 150 of FIG. 1) to perform a memory forensics analysis on the collected memory data. In some embodiments, the memory data collection processor (e.g., 120) may cause the collected memory data to be internally transmitted from the memory dump storage (e.g., 122 of FIG. 1) to an internal memory forensics analyzer (e.g., 126 of FIG. 1). In some embodiments, the optional memory forensics analyzer (e.g., 126) may be included in the memory data collection processor (e.g., 120). In some embodiments, the optional memory forensics analyzer (e.g., 126) may be included in another electronic component of the computing device (e.g., 100).

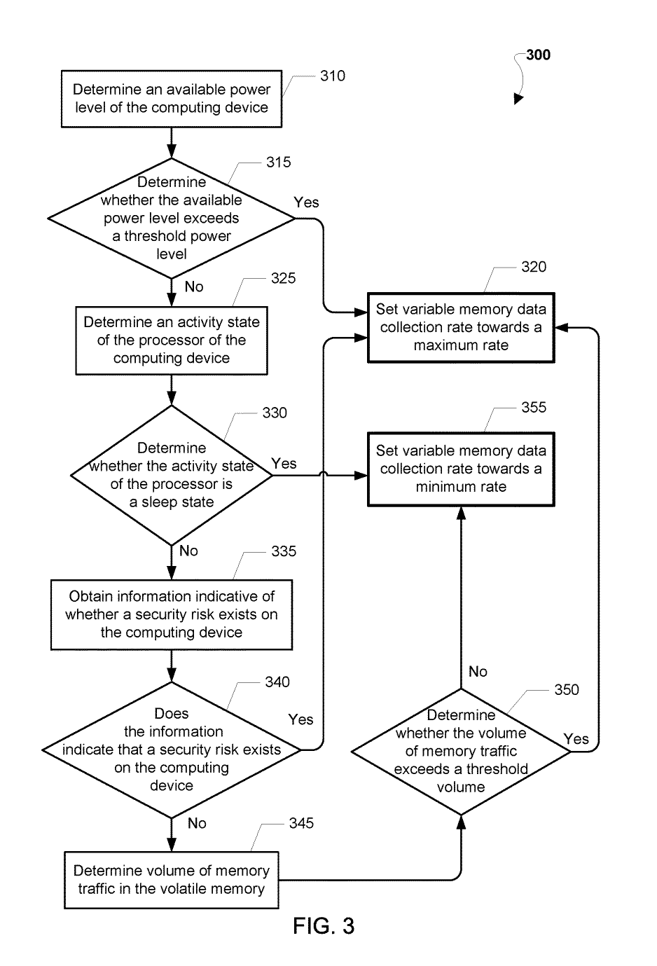

Online memory data collection may impose overhead in terms of power consumption, communication bandwidth utilization, and other processing costs. In some embodiments, online memory data collection may be performed at a variable memory collection rate based on a tradeoff between collecting memory data frequently and reducing such overhead. FIG. 3 is a flow diagram illustrating a method 300 of controlling a rate of performing the online memory data collection of FIG. 2 according to some embodiments. With reference to FIGS. 1-3, operations of the method 300 may be performed by a memory data collection processor (e.g., 120 of FIG. 1) of a computing device (e.g., 100 of FIG. 1).

In block 310, the memory data collection processor (e.g., 120) may determine an available power level of the computing device. For example, in some embodiments, when the power supply of the computing device (e.g., 140) is coupled to a continuous power source (e.g., plugged into a power wall outlet), the controller may determine that the available power level is 100 percent. In some embodiments, when the power supply (e.g., 140) is a battery, the controller may determine the percentage of available power remaining in the battery for powering the various electronic components of the computing device (e.g., 100).

In determination block 315, the memory data collection processor (e.g., 120) may determine whether the available power level exceeds a threshold power level. For example, in some embodiments, the memory data collection processor (e.g., 120) may set the threshold power level to an arbitrary power level (e.g., 75%).

In response to determining that the available power level exceeds the threshold power level (i.e., determination block 315=“Yes”), the memory data collection processor may adjust the variable memory data collection rate at or near a maximum rate (i.e., block 320). In some embodiments, the maximum rate may be the maximum rate at which a memory forensics analyzer (e.g., 126) is capable of analyzing set of memory data. For example, when the computing device (e.g., 100) receives power from a continuous power source or a battery having sufficient battery life, the memory data collection processor (e.g., 120) may perform online memory data collection at or near the maximum rate.

In response to determining that the available power level is equal to or less than the threshold power level (i.e., determination block 315=“No”), the memory data collection processor may determine an activity state of a processor of the computing device (e.g., the processor 110) in block 325. For example, the memory data collection processor (e.g., 120) may send signals (e.g., messages) to the processor (e.g., 110) to request information indicating whether the processor is operating in a sleep state (e.g., a low activity state indicative of low or no activity), an active state (e.g., a high activity state indicative the processor performing processor-intensive tasks), or an intermediate state between a sleep state and an active state. In some embodiments, the memory data collection processor (e.g., 120) may determine the activity state of the processor (e.g., 110) by accessing a memory register that indicates the activity state of the processor (e.g., activity state flags). The memory register may be maintained in the processor, in the memory (e.g., 112), or in another electronic component of the computing device (e.g., 100).

In determination block 330, the memory data collection processor (e.g., 120) may determine whether the activity state of the processor is a sleep state.

In response to determining that the activity state of the processor is a sleep state (i.e., determination block 330=“Yes”), the memory data collection processor (e.g., 120) may set the variable memory data collection rate at or near a minimum rate in block 355. For example, when the processor (e.g., 110) is sleeping, changes to memory data in the volatile memory (e.g., 114) due to read/write accesses are likely to be minimal. Thus, the need for collecting and performing memory forensics analysis on memory data in the volatile memory is also likely to be less.

In response to determining that the activity state of the processor does not equal a sleep state (i.e., determination block 330=“No”), the memory data collection processor (e.g., 120) may obtain information indicative of whether a security risk exists on the computing device in block 335. For example, in some embodiments, the information may include process identifiers (PIDs) of one or more instances of programs executing in the volatile memory (e.g., 114) that may be identified or marked as suspicious by a security monitoring application or service. In some embodiments, the processor (e.g., 110) or other electronic component of the computing device (e.g., 100) may execute the security monitoring application or service.

In determination block 340, the memory data collection processor (e.g., 120) may determine whether the information indicates that a security risk exists on the computing device (e.g., 100). For example, in some embodiments, identification of at least one process as suspicious may be sufficient to determine that a security risk exists in the computing device.

In response to determining that the information indicates that a security risk exists on the computing device (i.e., determination block 340=“Yes”), the memory data collection processor (e.g., 120) may set the variable memory data collection rate at or near a maximum rate in block 320.

In response to determining that the information does not indicate that a security risk exists (i.e., determination block 340=“No”), the memory data collection processor (e.g., 120) may determine the volume of memory traffic in the volatile memory in block 345. For example, in some embodiments, the volume of memory traffic may be determined by tracking the number of read/write accesses over a set period of time on an internal bus or other communications link between the processor (e.g., 110) and the volatile memory (e.g., 114). In some embodiments, other techniques may be used to determine the volume of memory traffic.

In determination block 350, the memory data collection processor (e.g., 120) may determine whether the volume of memory traffic exceeds a threshold volume. For example, in some embodiments, the threshold volume may be a predetermined number of read/write accesses tracked or detected between the processor (e.g., 110) and the volatile memory (e.g., 114). As the amount of memory traffic increases, the risk of malware being written to the volatile memory (e.g., 114) and executed by the processor (e.g., 110) or other electronic component may also increase.

In response to determining that the volume of memory traffic exceeds the threshold volume (i.e., determination block 350=“Yes”), the memory data collection processor (e.g., 120) may set the variable memory data collection rate at or near a maximum rate in block 320. Otherwise, in response to determining that the volume of memory traffic does not exceed the threshold volume (i.e., determination block 350=“No”), the memory data collection processor (e.g., 120) may set the memory collection rate at or near a minimum rate in block 355.

The operations in the method 300 may be performed periodically and/or in response to various events (e.g., a change in power state, detection of malware, etc.) to adjust the memory data collection rate to match current conditions of the computing device.

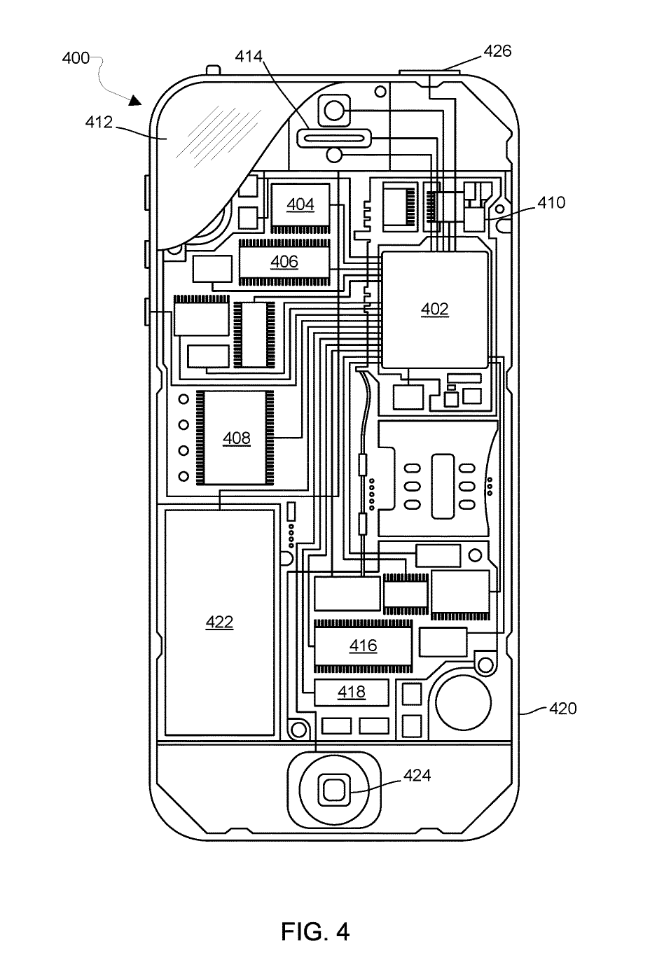

The various embodiments may be implemented on any of a variety of commercially available computing devices. For example, FIG. 4 is a schematic diagram illustrating components of a smartphone type mobile communication device 600 that may be configured to implement methods according to some embodiments, including the embodiments of the methods 200 and 300 described with reference to FIGS. 2 and 3. A mobile communication device 400 may include a processor 402 coupled to a touchscreen controller 404 and an internal memory 406. The processor 402 may be one or more multi-core integrated circuits designated for general or specific processing tasks. The internal memory 406 may be volatile or non-volatile memory. The touchscreen controller 404 and the processor 402 may also be coupled to a touchscreen panel 412, such as a resistive-sensing touchscreen, capacitive-sensing touchscreen, infrared sensing touchscreen, etc. Additionally, the display of the communication device 400 need not have touch screen capability. Additionally, the mobile communication device 400 may include a cellular network transceiver 408 coupled to the processor 402 and to an antenna 410 for sending and receiving electromagnetic radiation that may be connected to a wireless data link. The transceiver 408 and the antenna 410 may be used with the above-mentioned circuitry to implement various embodiment methods.

The mobile communication device 400 may have a cellular network transceiver 408 coupled to the processor 402 and to an antenna 410 and configured for sending and receiving cellular communications. The mobile communication device 400 may include one or more subscriber identity module (SIM) cards 416, 418 coupled to the transceiver 408 and/or the processor 402 and may be configured as described above.

The mobile communication device 400 may also include speakers 414 for providing audio outputs. The mobile communication device 400 may also include a housing 420, constructed of a plastic, metal, or a combination of materials, for containing all or some of the components discussed herein. The mobile communication device 400 may include a power source 422 coupled to the processor 402, such as a disposable or rechargeable battery. The rechargeable battery may also be coupled to the peripheral device connection port to receive a charging current from a source external to the communication device 400. The communication device 400 may also include a physical button 424 for receiving user inputs. The mobile communication device 400 may also include a power button 426 for turning the mobile communication device 400 on and off.

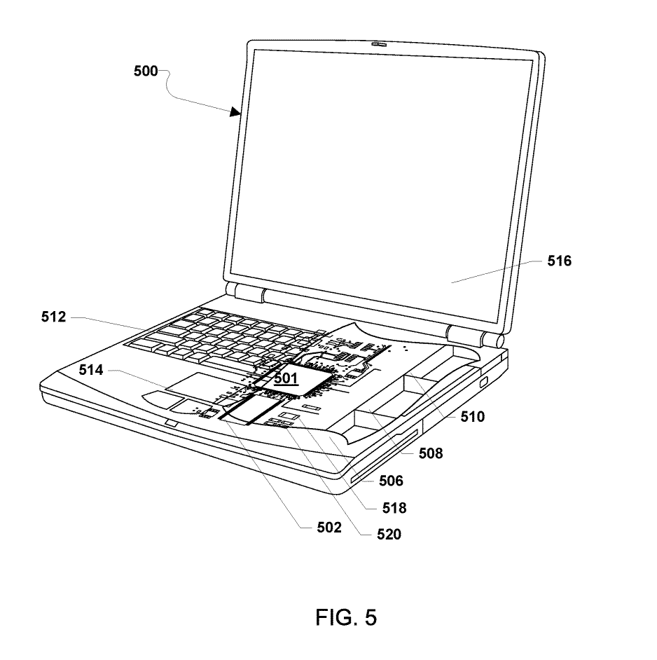

Other forms of computing devices, including personal computers and laptop computers, may be used to implementing the various embodiments. For example, FIG. 5 is a schematic diagram illustrating components of a laptop computing device 500 that may be configured to implement methods according to some embodiments, including the embodiments of the methods 200 and 300 described with reference to FIGS. 2 and 3. In some embodiments, the laptop computing device 500 may include a touch pad 514 that serves as the computer's pointing device, and thus may receive drag, scroll, and flick gestures similar to those implemented on mobile computing devices equipped with a touch screen display and described above. Such a laptop computing device 500 generally includes a processor 501 coupled to volatile internal memory 502 and a large capacity nonvolatile memory, such as a disk drive 506. The laptop computing device 500 may also include a compact disc (CD) and/or DVD drive 508 coupled to the processor 501. The laptop computing device 500 may also include a number of connector ports 510 coupled to the processor 501 for establishing data connections or receiving external memory devices, such as a network connection circuit for coupling the processor 501 to a network. The laptop computing device 500 may have one or more radio signal transceivers 518 (e.g., Peanut®, Bluetooth®, ZigBee®, Wi-Fi®, RF radio) and antennas 520 for sending and receiving wireless signals as described herein. The transceivers 518 and antennas 520 may be used with the above-mentioned circuitry to implement the various wireless transmission protocol stacks/interfaces. In a laptop or notebook configuration, the computer housing includes the touch pad 514, the keyboard 512, and the display 516 all coupled to the processor 501. Other configurations of the computing device may include a computer mouse or trackball coupled to the processor (e.g., via a universal serial bus (USB) input) as are well known, which may also be used in conjunction with the various embodiments.

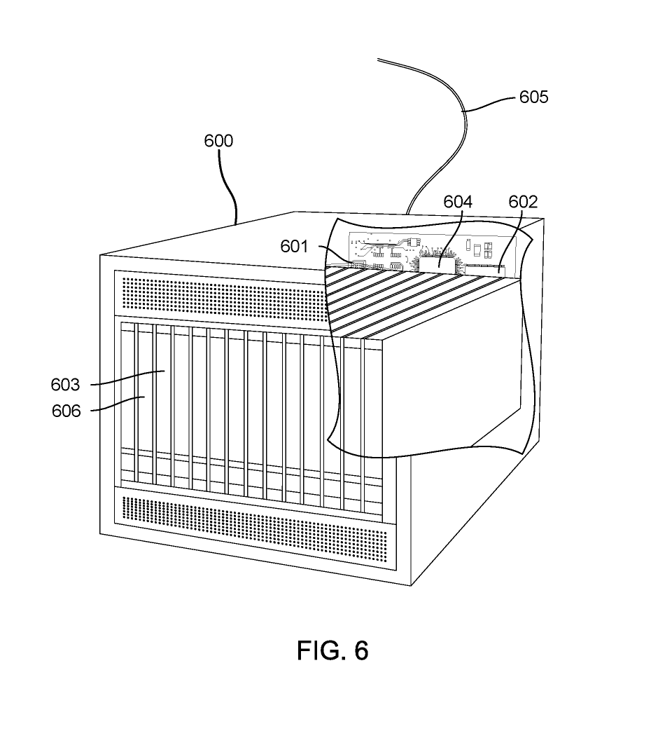

FIG. 6 is a schematic diagram illustrating components of a server 600 that may be configured to implement methods according to some embodiments, including the embodiments of the methods 200 and 300 described with reference to FIGS. 2 and 3. Such a server 600 typically includes a processor 601 coupled to volatile memory 602 and a large capacity nonvolatile memory, such as a disk drive 603. The server 600 may also include a floppy disc drive, compact disc (CD) or DVD disc drive 606 coupled to the processor 601. The server 600 may also include network access ports 604 coupled to the processor 601 for establishing data connections with a network 605, such as a local area network coupled to other broadcast system computers and servers.

The processor 601 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 602, 603 before they are accessed and loaded into the processor 601. The processor 601 may include internal memory sufficient to store the application software instructions.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a two or more microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of performing online memory data collection for memory forensics in a computing device, comprising:
determining, by a memory data collection processor, whether an operating system executing in a volatile memory of the computing device is trustworthy;
collecting memory data direct from the volatile memory in response to determining that the operating system is not trustworthy; and
calling, by the memory data collection processor, the operating system to collect memory data from the volatile memory in response to determining that the operating system is trustworthy.

2. The method of claim 1, wherein collecting memory data from the volatile memory comprises collecting the memory data from the volatile memory at a variable memory data collection rate determined by the memory data collection processor.

3. The method of claim 2, further comprising:
determining, by the memory data collection processor, whether an available power level of the computing device exceeds a threshold power level; and
setting, by the memory data collection processor, the variable memory data collection rate at or near a maximum rate in response to determining that the available power level of the computing device exceeds the threshold power level.

4. The method of claim 2, further comprising:
determining, by the memory data collection processor, whether an activity state of the processor of the computing device equals a sleep state; and
setting, by the memory data collection processor, the variable memory data collection rate at or near a minimum rate in response to determining that the activity state of the processor is equal to the sleep state.

5. The method of claim 2, further comprising:
obtaining, by the memory data collection processor, information indicating whether a security risk exists on the computing device; and
setting, by the memory data collection processor, the variable memory data collection rate at or near a maximum rate in response to determining that the information indicates that a security risk exists on the computing device.

6. The method of claim 2, further comprising:
determining, by the memory data collection processor, whether a volume of memory traffic in the volatile memory exceeds a threshold volume;
setting, by the memory data collection processor, the variable memory data collection rate at or near a maximum rate in response to determining that the volume of memory traffic in the volatile memory exceeds the threshold volume; and
setting, by the memory data collection processor, the variable memory data collection rate at or near a minimum rate in response to determining that the volume of memory traffic in the volatile memory does not exceed the threshold volume.

7. The method of claim 1, wherein collecting memory data from the volatile memory comprises:
collecting a partial data set from the volatile memory, wherein the partial data set comprises data associated with one or more suspicious processes executing in the volatile memory.

8. The method of claim 1, wherein collecting memory data from the volatile memory comprises:
collecting a partial data set from the volatile memory, wherein the partial data set comprises less than all data associated with each process executing in the volatile memory.

9. The method of claim 1, wherein determining whether the operating system executing in the volatile memory is trustworthy comprises:
determining, by the memory data collection processor, whether the operating system satisfies a real time integrity check.

10. A computing device, comprising:
a volatile memory;
a processor coupled to the volatile memory; and
a memory data collection processor coupled to the volatile memory and the processor and configured to:
determine whether an operating system executing in the processor is trustworthy;
collect memory data direct from the volatile memory in response to determining that the operating system is not trustworthy; and
call the operating system to collect memory data from the volatile memory in response to determining that the operating system is trustworthy.

11. The computing device of claim 10, wherein the memory data collection processor is further configured to collect the memory data from the volatile memory at a variable memory data collection rate determined by the memory data collection processor.

12. The computing device of claim 11, wherein the memory data collection processor is further configured to:
determine whether an available power level of the computing device exceeds a threshold power level; and
set the variable memory data collection rate at or near a maximum rate in response to determining that the available power level of the computing device exceeds the threshold power level.

13. The computing device of claim 11, wherein the memory data collection processor is further configured to:
determine whether an activity state of the processor of the computing device equals a sleep state; and
set the variable memory data collection rate at or near a minimum rate in response to determining that the activity state of the processor is equal to the sleep state.

14. The computing device of claim 11, wherein the memory data collection processor is further configured to:
obtain information indicating whether a security risk exists on the computing device; and
set the variable memory data collection rate at or near a maximum rate in response to determining that the information indicates that a security risk exists on the computing device.

15. The computing device of claim 11, wherein the memory data collection processor is further configured to:
determine whether a volume of memory traffic in the volatile memory exceeds a threshold volume;
set the variable memory data collection rate at or near a maximum rate in response to determining that the volume of memory traffic in the volatile memory exceeds the threshold volume; and
set the variable memory data collection rate at or near a minimum rate in response to determining that the volume of memory traffic in the volatile memory does not exceed the threshold volume.

16. The computing device of claim 10, wherein the memory data collection processor is further configured to collect a partial data set from the volatile memory.

17. The computing device of claim 10, wherein the memory data collection processor is further configured to determine whether the operating system satisfies a real time integrity check.

18. A computing device, comprising:
a volatile memory;
means for determining whether an operating system executing in the computing device is trustworthy;
means for collecting memory data direct from the volatile memory in response to determining that the operating system is not trustworthy; and
means for calling the operating system to collect memory data from the volatile memory in response to determining that the operating system is trustworthy.

19. The computing device of claim 18, further comprising:
means for determining whether an activity state of a processor of the computing device equals a sleep state;
means for setting a variable memory data collection rate at or near a minimum rate in response to determining that the activity state of the processor is equal to the sleep state; and
means for collecting the memory data from the volatile memory at the determined variable memory data collection rate.

20. The computing device of claim 18, further comprising:
means for obtaining information indicating whether a security risk exists on the computing device;
means for setting a variable memory data collection rate at or near a maximum rate in response to determining that the information indicates that a security risk exists on the computing device; and
means for collecting the memory data from the volatile memory at the determined variable memory data collection rate.

21. The computing device of claim 18, further comprising:
means for determining whether a volume of memory traffic in the volatile memory exceeds a threshold volume;
means for setting a variable memory data collection rate at or near a maximum rate in response to determining that the volume of memory traffic in the volatile memory exceeds the threshold volume;
means for setting the variable memory data collection rate at or near a minimum rate in response to determining that the volume of memory traffic in the volatile memory does not exceed the threshold volume; and
means for collecting the memory data from the volatile memory at the determined variable memory data collection rate.

22. The computing device of claim 18, wherein determining whether the operating system executing in the volatile memory is trustworthy comprises:
means for determining whether the operating system satisfies a real time integrity check.

23. A non-transitory processor-readable medium having stored thereon processor-executable instructions configured to cause a memory data collection processor of a computing device to perform operations comprising:
determining whether an operating system executing in the computing device is trustworthy;
collecting memory data direct from a volatile memory in response to determining that the operating system is not trustworthy; and
calling the operating system to collect memory data from the volatile memory in response to determining that the operating system is trustworthy.

24. The non-transitory processor-readable medium of claim 23, wherein the stored processor executable instructions are configured to cause the memory data collection processor of the computing device to perform operations further comprising:
determining whether an available power level of the computing device exceeds a threshold power level;
setting a variable memory data collection rate at or near a maximum rate in response to determining that the available power level of the computing device exceeds the threshold power level; and
collecting the memory data from the volatile memory at the determined variable memory data collection rate.

25. The non-transitory processor-readable medium of claim 23, wherein the stored processor executable instructions are configured to cause the memory data collection processor of the computing device to perform operations further comprising:
determining whether an activity state of a processor of the computing device equals a sleep state;
setting a variable memory data collection rate at or near a minimum rate in response to determining that the activity state of the processor is equal to the sleep state; and
collecting the memory data from the volatile memory at the determined variable memory data collection rate.

26. The non-transitory processor-readable medium of claim 23, wherein the stored processor executable instructions are configured to cause the memory data collection processor of the computing device to perform operations further comprising:
obtaining information indicating whether a security risk exists on the computing device;
setting a variable memory data collection rate at or near a maximum rate in response to determining that the information indicates that a security risk exists on the computing device; and
collecting the memory data from the volatile memory at the determined variable memory data collection rate.

27. The non-transitory processor-readable medium of claim 23, wherein the stored processor executable instructions are configured to cause the memory data collection processor of the computing device to perform operations further comprising:
determining whether a volume of memory traffic in the volatile memory exceeds a threshold volume;
setting a variable memory data collection rate at or near a maximum rate in response to determining that the volume of memory traffic in the volatile memory exceeds the threshold volume;
setting the variable memory data collection rate at or near a minimum rate in response to determining that the volume of memory traffic in the volatile memory does not exceed the threshold volume; and
collecting the memory data from the volatile memory at the determined variable memory data collection rate.

28. The non-transitory processor-readable medium of claim 23, wherein the stored processor executable instructions are configured to cause the memory data collection processor of the computing device to perform operations such that collecting memory data from the volatile memory comprises:
collecting a partial data set from the volatile memory, wherein the partial data set comprises data associated with one or more suspicious processes executing in the volatile memory.

29. The non-transitory processor-readable medium of claim 23, wherein the stored processor executable instructions are configured to cause the memory data collection processor of the computing device to perform operations such that collecting memory data from the volatile memory comprises:
collecting a partial data set from the volatile memory, wherein the partial data set comprises less than all data associated with each process executing in the volatile memory.

30. The non-transitory processor-readable medium of claim 23, wherein the stored processor executable instructions are configured to cause the memory data collection processor of the computing device to perform operations such that determining whether the operating system is trustworthy comprises:
determining whether the operating system satisfies a real time integrity check.
